(19) United States
(12) Patent Application Publication
(10) Pub. No.: US 2013/0106024 A1
(43) Pub. Date: May 2, 2013

(54) METHOD FOR PRODUCING BAUXITE-BASED HOLLOW CORUNDUM SPHERE

(71) Applicant: Jiabang Wang, Hangzhou (CN)

(72) Inventor: Jiabang Wang, Hangzhou (CN)

(73) Assignee: JIANGSU JINGBANG NEW MATERIAL CO., LTD., JIANGSU (CN)

(21) Appl. No.: 13/698,816

(22) PCT Filed: May 27, 2011
(86) PCT No.: PCT/CN2011/074768

§ 371 Date: Nov. 19, 2012

(30) Foreign Application Priority Data
Jun. 1, 2010 (CN) 201010188796.X

(51) Int. Cl. B29C 49/00

(52) U.S. Cl. CPC B29C 49/0005
USPC 264/431

(57) ABSTRACT

A method for producing bauxite-based hollow corundum sphere comprises the steps of: using high alumina bauxite as raw material, introducing desilication material, smelting and refining in a three phase alternating current submerged arc furnace or direct current submerged arc furnace, blowing with compressed air and sieving to obtain hollow corundum sphere with particle size of 0.2˜5 mm.

### FIELD OF THE TECHNOLOGY

The invention relates to a method for producing refractory material, in particular a method for producing bauxite-based hollow corundum sphere.

### BACKGROUND

Nowadays as the traditional energies are exhausted increasingly and new energies are developed slowly, the most urgent task at present is to develop an insert material with light weight, high strength, excellent thermal shock resistance and high use temperature which can meet the demands of lightweight structure high temperature furnaces, change the disadvantages of traditional ultra-high temperature furnaces caused by using heavy structure such as large calorific capacity, low heating rate, large energy consumption, short service life, large medium-term maintenance and so on, save energy, reduce energy consumption and contribute to constructing the resource-conserving society and humankind's sustainable development. As the lightweight insulating material achieves a low thermal conductivity by introducing pores, the contraction rate of the re-burning line of the lightweight material will be enhanced, refractoriness under load will be reduced, the high-temperature creep will be serious and the compressive strength will be reduced if a large amount of pores are introduced, thus the use temperature of the insulating material can hardly be increased and the application range will be limited, therefore it's the work focus of experts in every country to develop a method for producing new high temperature insulating materials. In the existing insulating materials, varieties of aluminum oxide insulating materials are the most, which have high use temperature and good insulating and energy-saving effect and are the focus insulating materials at present; wherein the application of lightweight aluminum oxide hollow sphere ceramic is a sign of technological progress of the insulating material, which overcomes the disadvantages of the original foam aluminum oxide products such as low strength and poor creep resistance at high temperature, can contact with the flame directly, can be used as high temperature lining structure materials, can promote the structure modification of the traditional high temperature furnace and lays foundations for designing new furnace structures. However at present aluminum oxide hollow spheres are generally produced with γ-Al₂O₃ powders, the raw materials are expensive and limit the applications of aluminum oxide hollow spheres as insulating materials in various fields. The high alumina bauxite is cheap, so the production cost of the hollow corundum sphere can be reduced greatly if high alumina bauxite is used as the raw material for producing the hollow corundum sphere with a wide market prospect. However the high alumina bauxite has a certain amount of impurities such as SiO₂, TiO₂ and Fe₂O₃ which have bad influences on producing hollow corundum spheres with high aluminum oxide content and must be removed. The desilication method for the high alumina bauxite comprises grinding and flotation, roasting and digestion process and so on, however these production processes involves liquid phase preparation, and the technical processes are complex and are not suitable to be used as the raw material purification method for producing hollow corundum spheres by the electro-fusion method.

### SUMMARY

The purpose of the invention is to provide a method for producing bauxite-based hollow corundum sphere, which takes high alumina bauxite as the raw material, introduces a certain amount of desilication materials, and removes SiO₂ through the reaction between the desilication material and SiO₂ in the high alumina bauxite at high temperature during the smelting process.

If single carbon material is used as the desilication material, the carbon material reacts with SiO₂ to generate gaseous volatile matter SiO so as to remove SiO₂ in the bauxite; SiO discharged from the melt unites with oxygen in the air to form SiO₂ collected via the dust-clearing system. Meanwhile in the melt, impurities such as Fe and Ti also can have reduction reactions to generate large proportion matters such as iron, titanium, which forms ferrosilicon alloy with one part of the silicon generated in the reduction reaction to subside in the bottom part of the furnace so as to separate from the molten aluminum oxide; moreover some oxides with low melting points are volatilized under heating condition such as sodium oxide and potassium oxide, so aluminum oxide is enriched and then hollow corundum spheres can be obtained by blowing the molten aluminum oxide. If the mixture of carbon material and iron-bearing material is used as the desilication material, SiO₂ is reduced to metal silicon, silicon and iron generate iron alloy and subside in the bottom part of the molten pool; the impurity Ti also will be reduced to generate titanium alloy to subside in the bottom part of the molten pool; sodium oxide and potassium oxide with low melting points become vapor and evaporate, so aluminum oxide in the bauxite is enriched and then hollow corundum spheres can be obtained by blowing the molten aluminum oxide.

The invention adopts technical proposals as follows:

The invention uses high alumina bauxite as raw material, introduces desilication material, heats and smelts in a three phase alternating current submerged arc furnace or direct current submerged arc furnace, refines for 10˜15 min after the temperature of the material reaches 2100˜2400° C. and desilication is finished, then turns-down and blows with compressed air to obtain hollow sphere.

Said desilication material is carbon material or the mixture of carbon material and iron-bearing material.

Said carbon material is one or more selected from graphite, petroleum coke, calcined petroleum coke, coal, coke, asphalt and charcoal; said iron-bearing material is one or more selected from iron chip, iron ore, iron oxide red, iron oxide black, scrap iron and scrap steel.

When single carbon material is used as said desilication material, the usage amount thereof ensures that the carbon mole number of carbon material is 1.2˜4 times of the SiO₂ mole number in high alumina bauxite.

When the mixture of carbon material and iron-bearing material is used as said desilication material, the usage amount thereof ensures that the carbon mole number of carbon material is 0.8˜3 times of the SiO2 mole number in the high alumina bauxite, the Fe mole number of the iron-bearing material is 2˜5 times of the SiO2 mole number in the high alumina bauxite.

The mass percentage of Al₂O₃ in said high alumina bauxite is greater than 80%.

The mass percentage of Al₂O₃ in said bauxite-based hollow corundum sphere is 92˜98%.

In said step of turning-down and blowing with compressed air to obtain hollow sphere, hollow spheres with sizes of 0.2˜5 mm are sieved as products.

When producing the bauxite-based hollow corundum sphere, the top part of the three phase alternating current or direct current submerged arc furnace is provided with an air extracting device; the iron-bearing molten material in the bottom part of the furnace cannot be used for blowing the hollow corundum sphere, and can be poured and cooled as brown corundum.

Advantages of the invention comprise:

The invention uses cheap bauxite as the raw material, purifies the bauxite in the smelting process by introducing desilication material, then blows the molten aluminum oxide to produce the hollow corundum spheres, therefore the production cost for producing the hollow corundum sphere is greatly reduced, and the use temperature of the produced hollow corundum sphere is similar to that of the hollow aluminum oxide sphere; the hollow corundum sphere has high compression strength, and exhibits higher mechanical strength and service temperature in comparison with the aluminum oxide insulating material produced by the burnt-out content addition method, foam method and gas generating method.

The invention is suitable to be used as aggregate of light casting material and has low damage rate during the construction process.

### DETAILED DESCRIPTION

### Example 1

The content of aluminum oxide in the selected high alumina bauxite is 88%, the content of silicon oxide is 7%, the content of iron oxide is 2%; graphite is used as the desilication material, the use amount thereof ensures that the C mole number in the graphite is 1.2 times of the SiO₂ mole number in the high alumina bauxite; above-mentioned raw materials are mixed uniformly according to the proportion and are added into the arc furnace to smelt after the preparation work; when the temperature of the materials reaches 1500° C., the air extracting device in the top part of the arc furnace is started; the mixed materials have reduction reactions in the smelting process, SiO₂ and impurities in the bauxite are removed gradually; the current is adjusted to refine for 30 min after the raw materials are molten completely; when the temperature reaches 2100° C., the electrode bars are lifted, then the furnace is immediately turned-down and the hollow corundum sphere is produced by blowing; the material in the bottom part of the furnace cannot be used to produce the hollow corundum sphere, but can be used to produce the brown corundum. The spheres with particle size between 0.2 mm and 5 mm are final products by sieving; Al₂O₃ in the produced hollow corundum sphere is equal to or greater than 96%.

### Example 2

The content of aluminum oxide in the selected high alumina bauxite is 83%, the content of silicon oxide is 7%, the content of iron oxide is 2%; coke and charcoal are used as the desilication material, the use amount thereof ensures that the C mole number in the coke and charcoal is 4 times of the SiO₂ mole number in the high alumina bauxite; above-mentioned raw materials are mixed uniformly according to the proportion and are added into the arc furnace to smelt after the preparation work; when the temperature of the materials reaches 1500° C., the air extracting device in the top part of the arc furnace is started; the mixed materials have reduction reactions in the smelting process, SiO₂ and impurities in the bauxite are removed gradually; the current is adjusted to refine for 30 min after the raw materials are molten completely; when the temperature reaches 2100° C., the electrode bars are lifted, then the furnace is immediately turned-down and the hollow corundum sphere is produced by blowing; the material in the bottom part of the furnace cannot be used to produce the hollow corundum sphere, but can be used to produce the brown corundum. The spheres with particle size between 0.2 mm and 5 mm are final products by sieving; Al₂O₃ in the produced hollow corundum sphere is equal to or greater than 93%.

### Example 3

The content of aluminum oxide in the selected high alumina bauxite is 80%, the content of silicon oxide is 11%, the content of iron oxide is 1%; the desilication material is made by mixing petroleum coke, calcined petroleum coke and coal with iron scrap, the total use amount of the petroleum coke, calcined petroleum coke and coal ensures that the C mole number thereof is 0.8 times of the SiO₂ mole number in the high alumina bauxite, the use amount of the iron scrap ensures that Fe mole number thereof is 5 times of the SiO₂ mole number in the high aluminum bauxite; above-mentioned raw materials are mixed uniformly according to the proportion and are added into the arc furnace to smelt after the preparation work; when the temperature of the materials reaches 1500° C., the air extracting device in the top part of the arc furnace is started; the mixed materials have reduction reactions in the smelting process, SiO₂ and impurities in the bauxite are removed gradually; the current is adjusted to refine for 30 min after the raw materials are molten completely; when the temperature reaches 2400° C., the electrode bars are lifted, then the furnace is immediately turned-down and the hollow corundum sphere is produced by blowing; the material in the bottom part of the furnace cannot be used to produce the hollow corundum sphere, but can be used to produce the brown corundum; if part of the material cannot be blown to spheres or damaged, the material can be added into the furnace to smelt next time. The spheres with particle size between 0.2 mm and 5 mm are final products by sieving; Al₂O₃ in the produced hollow corundum sphere is equal to or greater than 92%.

### Example 4

The content of aluminum oxide in the selected high alumina bauxite is 88%, the content of silicon oxide is 6%, the content of iron oxide is 0.5%; the desilication material is made by mixing coke, asphalt and charcoal with iron ore, iron oxide red and iron oxide black; the total use amount of the coke, asphalt and charcoal ensures that the C mole number thereof is 1.5 times of the SiO₂ mole number in the high alumina bauxite, the use amount of the iron ore, iron oxide red and iron oxide black ensures that Fe mole number thereof is 2 times of the SiO₂ mole number in the high aluminum bauxite; above-mentioned raw materials are mixed uniformly according to the proportion and are added into the arc furnace to smelt after the preparation work; when the temperature of the materials reaches 1500° C., the air extracting device in the top part of the arc furnace is started; the mixed materials have reduction reactions in the smelting process, SiO₂ and impurities in the bauxite are removed gradually; the current is adjusted to refine for 30 min after the raw materials are molten completely; when the temperature reaches 2200° C., the electrode bars are lifted, then the furnace is immediately turned-down and the hollow corundum sphere is produced by blowing; the material in the bottom part of the furnace cannot be used to produce the hollow corundum sphere, but can be used to produce the brown corundum; if part of the material cannot be blown to spheres or damaged, the material can be added into the furnace to smelt next time. The spheres with particle size between 0.2 mm˜5 mm are final products by sieving; Al₂O₃ in the produced hollow corundum sphere is equal to or greater than 98%.

### Example 5

The content of aluminum oxide in the selected high alumina bauxite is 86%, the content of silicon oxide is 8%, the content of iron oxide is 1%; the desilication material is made by mixing coke and charcoal with iron oxide red, scrap iron and scrap steel, the total use amount of the coke and charcoal ensures that the C mole number thereof is 3 times of the SiO₂ mole number in the high alumina bauxite, the total use amount of the iron oxide red, scrap iron and scrap steel ensures that Fe mole number thereof is 3 times of the SiO₂ mole number in the high aluminum bauxite; above-mentioned raw materials are mixed uniformly according to the proportion and are added into the arc furnace to smelt after the preparation work; when the temperature of the materials reaches 1500° C., the air extracting device in the top part of the arc furnace is started; the mixed materials have reduction reactions in the smelting process, SiO₂ and impurities in the bauxite are removed gradually; the current is adjusted to refine for 30 min after the raw materials are molten completely; when the temperature reaches 2300° C., the electrode bars are lifted, then the furnace is immediately turned-down and the hollow corundum sphere is produced by blowing; the material in the bottom part of the furnace cannot be used to produce the hollow corundum sphere, but can be used to produce the brown corundum; if part of the material cannot be blown to spheres or damaged, the material can be added into the furnace to smelt next time. The spheres with particle size between 0.2 mm and 5 mm are final products by sieving; Al₂O₃ in the produced hollow corundum sphere is equal to or greater than 95%.

1. A method for producing a bauxite-based hollow corundum sphere, the method comprising:
utilizing high alumina bauxite as a raw material;
introducing a desilication material;
heating and smelting in a three phase alternating current submerged arc furnace or direct current submerged arc furnace; and
refining for 10˜15 min after a temperature of the material reaches 2100˜2400° C. and desilication is finished, then turning-down and blowing with compressed air to obtain the hollow sphere.

2. The method for producing bauxite-based hollow corundum sphere according to claim 1, wherein: said desilication material is a carbon material or a mixture of carbon material and iron-bearing material.

3. The method for producing bauxite-based hollow corundum sphere according to claim 2, wherein: said carbon material is one or more selected from graphite, petroleum coke, calcined petroleum coke, coal, coke, asphalt and charcoal; said iron-bearing material is one or more selected from iron chip, iron ore, iron oxide red, iron oxide black, scrap iron and scrap steel.

4. The method for producing bauxite-based hollow corundum sphere according to claim 1, wherein: when single carbon material is used as said desilication material, the usage amount thereof ensures that the carbon mole number of carbon material is 1.2˜4 times of the SiO₂ mole number in high alumina bauxite.

5. The method for producing bauxite-based hollow corundum sphere according to claim 1, wherein: when the mixture of carbon material and iron-bearing material is used as said desilication material, the usage amount thereof ensures that the carbon mole number of carbon material is 0.8˜3 times of the SiO2 mole number in the high alumina bauxite, the Fe mole number of the iron-bearing material is 2˜5 times of the SiO2 mole number in the high alumina bauxite.

6. The method for producing bauxite-based hollow corundum sphere according to claim 1, wherein: the mass percentage of Al₂O₃ in said high alumina bauxite is greater than 80%.

7. The method for producing bauxite-based hollow corundum sphere according to claim 1, wherein: the mass percentage of Al₂O₃ in said bauxite-based hollow corundum sphere is 92˜98%.

8. The method for producing bauxite-based hollow corundum sphere according to claim 1, wherein: in said step of turning-down and blowing with compressed air to obtain the hollow sphere, hollow spheres with sizes of 0.2˜5 mm are sieved as products.
